(19) United States
(12) Patent Application Publication
(10) Pub. No.: US 2022/0080639 A1
(43) Pub. Date: Mar. 17, 2022

(54) MOLD CLAMPING DEVICE, INJECTION MOLDING MACHINE, MOLD THICKNESS ADJUSTING DEVICE, AND MOLD THICKNESS ADJUSTING METHOD

(71) Applicant: THE JAPAN STEEL WORKS, LTD., Tokyo (JP)

(72) Inventors: Koji MATSUZAKI, Tokyo (JP); Takafumi NISHIBE, Tokyo (JP)

(73) Assignee: THE JAPAN STEEL WORKS, LTD., Tokyo (JP)

(21) Appl. No.: 17/476,585

(22) Filed: Sep. 16, 2021

(30) Foreign Application Priority Data
Sep. 17, 2020 (JP) 2020-156099

(51) Int. Cl. B29C 45/66; B29C 45/17

(52) U.S. Cl. CPC B29C 45/661; B29C 45/1747

(57) ABSTRACT

A mold clamping device includes: a fixed platen; a movable platen facing the fixed platen; a mold clamping housing; a plurality of tie bars connecting the fixed platen and the mold clamping housing; a plurality of tie bar nuts respectively provided on the plurality of tie bars, and configured to adjust a distance between the fixed platen and the mold clamping housing; a toggle mechanism provided between the mold clamping housing and the movable platen; a plurality of rotation members respectively provided integrally with the plurality of tie bar nuts; one endless string-shaped force transmission member wound around the plurality of rotation members; and a rotation driver configured to transmit a driving force to at least one of the plurality of the tie bar nuts as a drive target tie bar nut.

### CROSS-REFERENCE TO RELATED APPLICATIONS

This application is based on and claims priority under 35 USC 119 from Japanese Patent Application No. 2020-156099 filed on Sep. 17, 2020, the contents of which are incorporated herein by reference.

### TECHNICAL FIELD

The present disclosure relates to a mold thickness adjusting device for a mold clamping device including a toggle mechanism.

### BACKGROUND

Among mold clamping devices constituting an injection molding machine, a mold clamping device including a toggle mechanism includes: a fixed platen to which a fixed side mold is attached; a movable platen to which a movable side mold is attached; a mold clamping housing; a plurality of tie bars connecting the fixed platen and the mold clamping housing; a toggle mechanism provided between the mold clamping housing and the movable platen; and the like. Therefore, when the toggle mechanism is bent or stretched, the movable platen is driven with respect to the mold clamping housing, and the molds can be opened or closed to be clamped by the movable platen.

A mold clamping device including a toggle mechanism is provided with a mold thickness adjusting device, for example, as described in JP-A-2008-284788. The mold thickness adjusting device is configured as follows.

Tip ends of the tie bars are male screws which are screwed with tie bar nuts, respectively; and the tie bar nuts are accommodated in recesses formed in the mold clamping housing. Sprockets are fixed to the tie bar nuts, respectively, and one chain is wound around the sprockets such that the sprockets rotate in conjunction with each other. The mold clamping housing is provided with a motor for mold thickness adjustment, and the chain is also wound around a drive sprocket provided on the motor. Therefore, when the mold thickness adjusting motor is driven, all the tie bar nuts are rotated in conjunction with each other by the chain and the sprockets, and a distance between the fixed platen and the mold clamping housing, that is, a tie bar effective length is adjusted. That is, a mold thickness is adjusted.

In many mold clamping devices, the number of tie bars is four, and therefore, the number of tie bar nuts and sprockets is also four. Although the chain is wound around the four sprockets and the drive sprocket of the mold thickness adjusting motor, the chain needs to be wound around at least ¼ or more of a circumference of the sprocket so as not to idle with the sprockets. Since a mold opening and closing mechanism that drives the toggle mechanism is provided at a center of the mold clamping housing, the mold thickness adjusting motor and the drive sprocket need to be provided at a side portion of the mold clamping housing. Therefore, in order to satisfy a condition for winding the chain, generally, an idler sprocket needs to be additionally provided in the mold clamping housing, which causes a problem of an increase in the number of components. When the idler sprocket is provided, a load is applied to a rotation shaft of the idler sprocket, and thus there is a concern that the rotation shaft may be damaged.

Other problems and novel features will become apparent from description of the present specification and the accompanying drawings.

### SUMMARY

The present disclosure relates to a mold clamping device including a mold thickness adjusting device having a pre-determined configuration. The mold clamping device includes: a fixed platen; a movable platen; a mold clamping housing; a plurality of tie bars connecting the fixed platen and the mold clamping housing; a toggle mechanism provided between the mold clamping housing and the movable plate. The mold thickness adjusting device provided with such a mold clamping device is configured as follows. First, a tie bar nut is provided with each of a plurality of the tie bars. A rotation member is provided integrally with each of the tie bar nuts. One endless string-shaped force transmission member is wound around the plurality of rotation members. At least one of the plurality of tie bar nuts is determined as a drive target tie bar nut. A driving force is transmitted to the drive target tie bar nut directly by providing a rotation drive unit.

According to the present disclosure, a mold clamping device, which does not need to be additionally provided with a member such as an idler sprocket that may be damaged, can be provided.

### BRIEF DESCRIPTION OF DRAWINGS

FIG. 1 is a front view showing an injection molding machine according to the present illustrative embodiment;

FIG. 2 is a rear view of a mold clamping device according to the present illustrative embodiment;

FIG. 3 is a cross-sectional view showing a part of the mold clamping device according to the present illustrative embodiment;

FIG. 4 is a rear view of a mold clamping device according to a second illustrative embodiment of the present disclosure;

FIG. 5 is a rear view of the mold clamping device according to the second illustrative embodiment of the present disclosure; and

FIG. 6 is a rear view of a mold clamping device according to a comparative example.

### DETAILED DESCRIPTION

Hereinafter, specific illustrative embodiments will be described in detail with reference to the drawings. However, the present disclosure is not limited to the following illustrative embodiments. The following description and drawings arc simplified as appropriate to clarify the description. In the drawings, the same elements are denoted by the same reference numerals, and repeated description thereof is omitted as necessary. In addition, hatching may be omitted to avoid complicating the drawings.

<Injection Molding Machine>

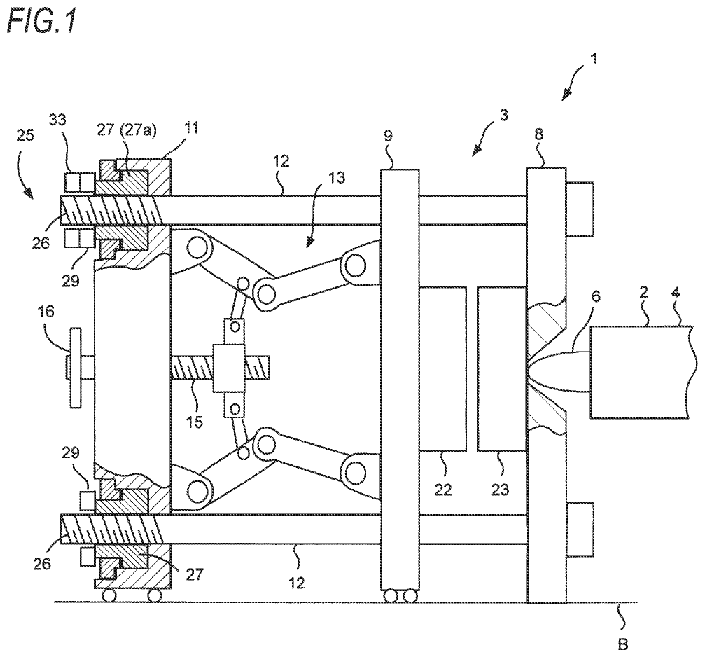

As shown in FIG. 1, an injection molding machine 1 according to the present illustrative embodiment is a horizontal injection molding machine provided on a bed B, and is schematically configured by an injection device 2 and a mold clamping device 3. The injection device 3 includes a heating cylinder 4 and a screw (not shown) provided in the heating cylinder 4. The injection device 3 melts an injection material and injects the melted injection material from an injection nozzle 6 provided at a tip end of the heating cylinder 4.

<Mold Clamping Device>

The mold clamping device 3 according to the present illustrative embodiment is a toggle type mold clamping device. That is, the mold clamping device 3 includes a fixed platen 8 fixed to the bed B, a movable platen 9 provided to be slidable on the bed B so as to face the fixed platen 8, a mold clamping housing 11 provided to be slidable with respect to the bed B, four tie bars 12 connecting the mold clamping housing 11 and the fixed platen 8, and a toggle mechanism 13 provided between the mold clamping housing 11 and the movable platen 9.

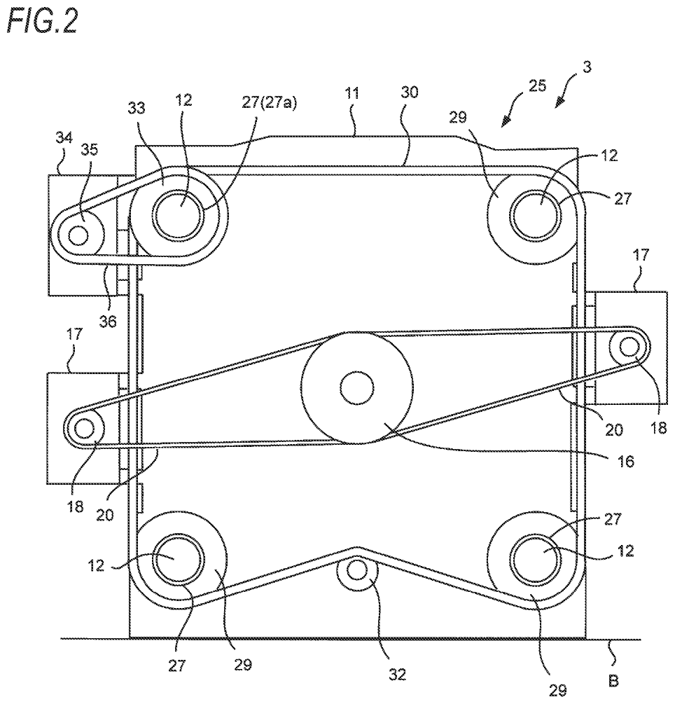

The toggle mechanism 13 is driven by a ball screw mechanism 15, and the ball screw mechanism 15 is provided with a large pulley 16. As shown in FIG. 2, the mold clamping housing 11 is provided with two mold opening and closing motors 17, 17, and timing belts 20, 20 are wound around the large pulley 16 and drive pulleys 18, 18 provided on the mold opening and closing motors 17, 17. Therefore, when the mold opening and closing motors 17, 17 are driven, the toggle mechanism 13 is bent or stretched to enable the movable platen 9 to slide, and molds 22, 23 respectively provided on the fixed platen 8 and the movable platen 9 are opened or closed to be clamped. In the mold clamping device 3, since the large pulley 16 is provided in the mold clamping housing 11 as described above, there is no room for providing other members in a central portion of the mold clamping housing 11. Under this constraint, a mold thickness adjusting device 25 according to the present illustrative embodiment is designed.

<Mold Thickness Adjusting Device>

The mold thickness adjusting device 25 according to the present illustrative embodiment is configured as follows. First, as shown in FIG. 1, male screws 26 are formed at tip ends of the four tie bars 12. The male screws 26 are screwed into tie bar nuts 27, and the tie bar nuts 27 are accommodated in recesses formed in the mold clamping housing 11.

Predetermined rotation members 29 are fixed to the tie bar nuts 27, and as shown in FIG. 2, one endless string-shaped force transmission member 30 is wound around the rotation members 29. Therefore, when one tie bar nut 27 rotates, the rotation members 29 rotate in conjunction with each other via the force transmission member 30, and thereby the other tie bar nuts 27 rotate in synchronization with each other. Therefore, effective lengths of the four tie bars 12, 12 can be simultaneously adjusted.

The rotation members 29 that rotate the tie bar nuts 27 in synchronization with each other and the force transmission member 30 can be constituted by, for example, a pulley and a timing belt respectively, and any members can be used as long as the members can rotate in conjunction with each other. However, in the present illustrative embodiment, the rotation members 29 are formed of sprockets, that is, tie bar nut side sprockets 29, and the force transmission member 30 is formed of a chain 30. As shown in FIG. 2, the mold clamping housing 11 is provided with a tension adjusting member 32 that adjusts a tension of the chain 30 to prevent loosening of the chain 30. The tension adjusting member 32 has, for example, a configuration in which a small sprocket is pivotally supported by a bolt. Although the tension adjusting member 32 can be provided at any position, in the present illustrative embodiment, the tension adjusting member 32 is disposed between the two tie bar nut side sprockets 29, 29 disposed in a lower portion of the four tie bar nut side sprockets 29.

The mold thickness adjusting device 25 according to the present illustrative embodiment is characterized in a method and a unit that drive the tie bar nuts 27. Specifically, one of the four tie bar nuts 27 is set as a drive target tie bar nut 27a, and the drive target tie bar nut 27a is rotated by a predetermined rotation drive unit. When the drive target tie bar nut 27a is rotated by the rotation drive unit, the other tie bar nuts 27 are rotated in conjunction with each other.

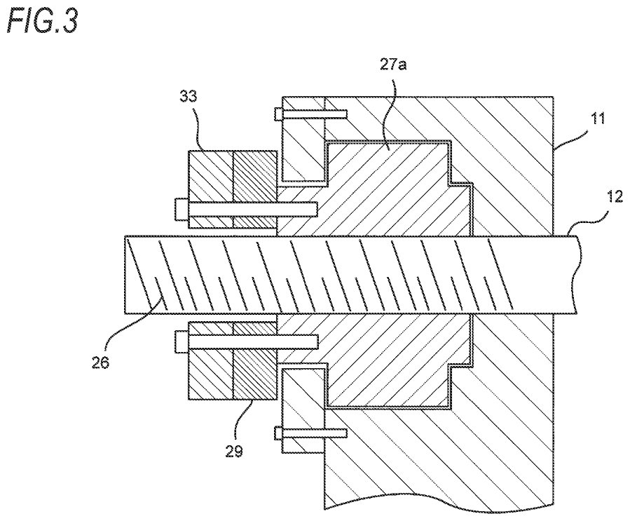

As shown in FIG. 1, as the drive target tie bar nut 27a according to the present illustrative embodiment, the tie bar nut 27 disposed at an upper portion is selected from the four tie bar nuts 27. The drive target tie bar nut 27a is shown in an enlarged manner in FIG. 3, and the tie bar nut side sprocket 29 and a drive sprocket 33 are fixed to each other. That is, the two sprockets are coaxially fixed to the drive target tie bar nut 27a. As shown in FIG. 2, a mold thickness adjusting motor 34 is provided on a side of the mold clamping housing 11, and a drive chain 36 is wound around a motor side sprocket 35 provided on the motor 34 and a drive sprocket 33. That is, the mold thickness adjusting motor 34, the motor side sprocket 35, the drive chain 36 and the drive sprocket 33 serve as a rotation drive unit, and rotate the drive target tie bar nut 27a.

In this way, in the mold thickness adjusting device 25 according to the present illustrative embodiment, the unit that drives the tie bar nuts 27 directly rotationally drives one tie bar nut 27, that is, the drive target tie bar nut 27a, and thus it is not necessary to separately provide a sprocket or the like that drives the chain 30. Therefore, it is ensured that the chain 30 is wound around ¼ or more of a circumference of each of the tie bar nut side sprockets 29, and it is not particularly necessary to provide an idler sprocket or the like in the mold clamping housing 11. Since the mold thickness adjusting motor 34 constituting the rotation drive unit is provided on a side of the mold clamping housing 11, the mold thickness adjusting motor 34 does not protrude from a bottom surface of the mold clamping housing 11. Therefore, the mold thickness adjusting motor 34 does not affect a machine length of the injection molding machine 1.

<Modification of Mold Thickness Adjusting Device>

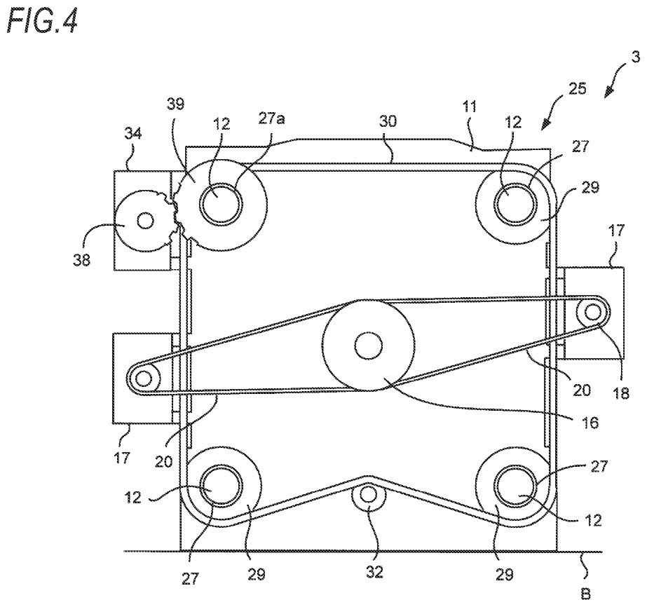

The rotation drive unit that drives the drive target tie bar nut 27a can be modified as shown in FIG. 4. That is, in this illustrative embodiment, a rotation unit includes the mold thickness adjusting motor 34, and a drive gear 39 configured such that a motor side gear 38 provided on the motor 34 is fixed to the drive target tie bar nut 27a. The motor side gear 38 and the drive gear 39 mesh with each other, and a rotational force of the mold thickness adjusting motor 34 is transmitted to the drive target tie bar nut 27a.

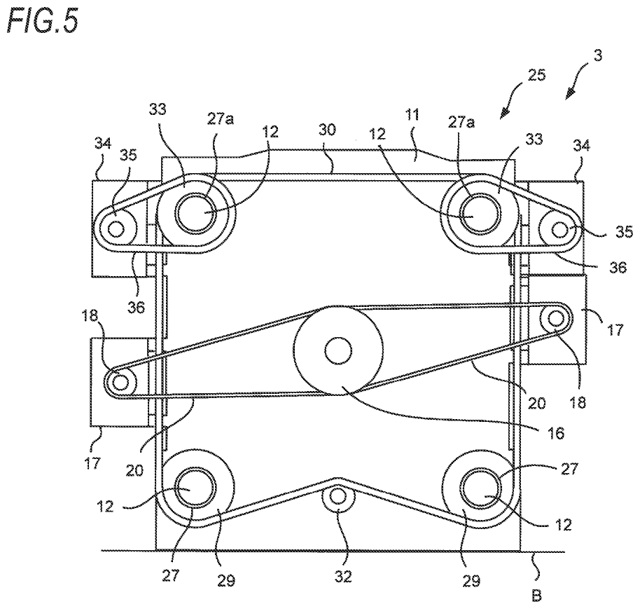

Although it has been described that one drive target. tie bar nut 27a is provided, the number of the drive target tie bar nuts 27a may be two or more as shown in FIG. 5. In this illustrative embodiment, among the four tie bar nuts 27, the two tie bar nuts 27, 27 disposed at an upper portion are the drive target tie bar nuts 27a, 27a. Drive sprockets 33, 33 are respectively fixed to the two drive target tie bar nuts 27a, 27a, and are rotated by mold thickness adjusting motors 34, 34 respectively provided on the drive target tie bar nuts 27a, 27a.

<Modification of Mold Clamping Device>

The mold clamping device 3 according to the present illustrative embodiment is provided with four tie bars 12, but the present disclosure can be similarly implemented with three tie bars, five or more tie bars. Regardless of the number of the tie bars 12, one or more of the tie bar nuts 27 provided on the tie bars 12 may be set as the drive target tie bar nut 27a, and the drive target tie bar nut 27a may be rotated by the rotation drive unit.

Comparative Example

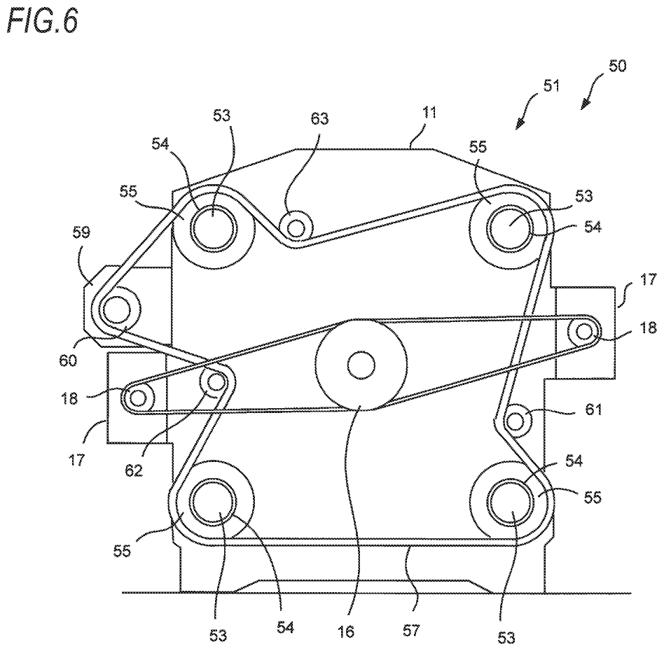

The inventors of the present application have designed a mold clamping device 50 and a mold thickness adjusting device 51 shown in FIG. 6 as a comparative example with respect to the illustrative embodiment of the present disclosure. Also, in the mold clamping device 50, four tie bars 53 are provided, tie bar nuts 54 are provided on the tie bars 53, and tie bar nut side sprockets 55 are fixed to the tie bar nuts 54. One chain 57 is wound around the tie bar nut side sprockets 55.

In a design of this comparative example, the chain 57 is driven by a predetermined drive unit as in the related art without directly rotating the tie bar nuts 27. That is, the mold thickness adjusting motor 59 and a motor side sprocket 60 are used as the drive unit. However, the motor side sprocket 60 does not drive the tie bar nuts 27, but drives the chain 57 by the chain being wound therearound.

In the design, the same conditions as those in the illustrative embodiment of the present disclosure are imposed. That is, the mold thickness adjusting motor 59 serving as the drive unit is provided on a side of the mold clamping housing 11 so as not to affect a machine length, the large pulley 16 is provided at a central portion of the mold clamping housing 11, so that members constituting the mold thickness adjusting device 51 are not disposed around the large pulley 16, and the chain 57 is wound around ¼ or more of a circumference of each of the tie bar nut side sprockets 55.

As a result of these design conditions being imposed, in the mold thickness adjusting device 51 according to the comparative example, it is necessary to provide two idler sprockets 62, 63 in addition to a tension adjusting member 61. In this case, a large force as a resultant force acts on the idler sprockets 62, 63 due to a tension of the chain 57, so that there is a high possibility that bolts that pivotally support the idler sprockets 62, 63 will be damaged. In particular, it can be said that the chain 57 is wound around ¼ or more of a circumference of the idler sprocket 62, so that the resultant force is large and the possibility of damage of the bolt is high.

Compared to such a comparative example, the mold clamping device 3 and the mold thickness adjusting device 25 according to the present illustrative embodiment are superior without a risk of damage to the members.

Here, the present disclosure is not limited to the above-described illustrative embodiment, and modifications can be made without departing from the scope of the present disclosure. A plurality of examples described above can be implemented in combination as appropriate.

What is claimed is:

1. A mold clamping device comprising:
a fixed platen;
a movable platen facing the fixed platen;
a mold clamping housing;
a plurality of tie bars connecting the fixed platen and the mold clamping housing;
a plurality of tie bar nuts respectively provided on the plurality of tie bars and configured to adjust a distance between the fixed platen and the mold clamping housing;
a toggle mechanism provided between the mold clamping housing and the movable platen;
a plurality of rotation members respectively provided integrally with the plurality of tie bar nuts;
one endless string-shaped force transmission member wound around the plurality of rotation members; and
a rotation driver configured to transmit a driving force to at least one of the plurality of the tie bar nuts as a drive target tie bar nut.

2. The mold clamping device according to claim 1,
wherein the plurality of rotation members are tie bar nut side sprockets, and
wherein the force transmission member is a chain.

3. The mold clamping device according to claim 2,
wherein the rotation driver includes:
a motor;
a motor side sprocket provided on the motor;
a drive sprocket integrally provided with the drive target tie bar nut; and
a drive chain wound around the motor side sprocket and the drive sprocket.

4. The mold clamping device according to claim 1,
wherein the plurality of tie bars include four tie bars, and
wherein the plurality of tie bar nuts include four tie bar nuts.

5. The mold damping device according to claim 1,
wherein the drive target tie bar nut is a tie bar nut disposed at a position of an upper portion of the mold clamping housing among the plurality of tie bar nuts.

6. The mold clamping device according to claim 1, further comprising:
a tension adjusting member configured to adjust a tension of the force transmission member,
wherein the tension adjusting member is disposed between two rotation members disposed at positions of a lower portion of the mold clamping housing among the plurality of rotation members.

7. An injection molding machine comprising:
a mold clamping device configured to clamp a mold; and
an injection device configured to inject an injection material into the mold,
wherein the mold clamping device includes:
a fixed platen;
a movable platen facing the fixed platen;
a mold clamping housing;
a plurality of tie bars connecting the fixed platen and the mold clamping housing;
a plurality of tie bar nuts provided on the plurality of tie bars, respectively, and configured to adjust a distance between the fixed platen and the mold clamping housing;
a toggle mechanism provided between the mold clamping housing and the movable platen;
a plurality of rotation members provided integrally with the plurality of tie bar nuts, respectively;
one endless string-shaped force transmission member wound around the plurality of rotation members; and
a rotation driver configured to transmit a driving force to at least one of the plurality of tie bar nuts as a drive target tie bar nut.

8. The injection molding machine according to claim 7,
wherein the plurality of rotation members are tie bar nut side sprockets, and
wherein the force transmission member is a chain.

9. The injection molding machine according to claim 8,
wherein the rotation driver includes:
a motor;
a motor side sprocket provided on the motor;
a drive sprocket integrally provided with the drive target tie bar nut; and
a drive chain wound around the motor side sprocket and the drive sprocket.

10. The injection molding machine according to claim 7,
wherein the plurality of tie bars include four tie bars, and
wherein the plurality of tie bar nuts include four tie bar nuts.

11. The injection molding machine according to claim 7,
wherein the drive target tie bar nut is a tie bar nut disposed at a position of an upper portion of the mold clamping housing among the plurality of tie bar nuts.

12. The injection molding machine according to claim 7, further comprising:
a tension adjusting member configured to adjust a tension of the force transmission member,
wherein the tension adjusting member is disposed between two rotation members disposed at positions of a lower portion of the mold clamping housing among the plurality of rotation members.

13. A mold thickness adjusting device provided in a mold clamping device including: a fixed platen; a movable platen; a mold clamping housing; a plurality of tie bars connecting the fixed platen and the mold clamping housing; and a toggle mechanism provided between the mold clamping housing and the movable platen, the mold thickness adjusting device comprising:
a plurality of tie bar nuts respectively provided on the plurality of tie bars, and configured to adjust a distance between the fixed platen and the mold clamping housing;
a plurality of rotation members respectively provided integrally with the plurality of tie bar nuts;
one endless string-shaped force transmission member wound around the plurality of rotation members; and
a rotation driver configured to transmit a driving force to at least one of the plurality of tie bar nuts as a drive target tie bar nut.

14. The mold thickness adjusting device according to claim 13,
wherein the plurality of rotation members are tie bar nut side sprockets, and
wherein the force transmission member is a chain.

15. The mold thickness adjusting device according to claim 14,
wherein the rotation driver includes:
a motor;
a motor side sprocket provided on the motor;
a drive sprocket integrally provided with the drive target tie bar nut; and
a drive chain wound around the motor side sprocket and the drive sprocket.

16. The mold thickness adjusting device according to claim 13,
wherein the plurality of tie bars include four tie bars, and
wherein the plurality of tie bar nuts include four tie bar nuts.

17. The mold thickness adjusting device according to claim 13,
wherein the drive target tie bar nut is a tie bar nut disposed at a position of an upper portion of the mold clamping housing among the plurality of tie bar nuts.

18. The mold thickness adjusting device according to claim 13, further comprising:
a tension adjusting member configured to adjust a tension of the force transmission member,
wherein the tension adjusting member is disposed between two rotation members disposed at positions of a lower portion of the mold clamping housing among the plurality of rotation members.
